(19) United States
(12) Patent Application Publication
(10) Pub. No.: US 2020/0384405 A1
(43) Pub. Date: Dec. 10, 2020

(54) EXHAUST GAS PURIFICATION SYSTEM

(71) Applicant: Jung-Tsung WEI, Tainan City (TW)

(72) Inventor: Jung-Tsung WEI, Tainan City (TW)

(21) Appl. No.: 16/840,739

(22) Filed: Apr. 6, 2020

(30) Foreign Application Priority Data
Jun. 5, 2019 (TW) 108119548
Jan. 3, 2020 (TW) 109200093

(51) Int. Cl. B01D 47/06; F01N 3/08

(52) U.S. Cl. CPC B01D 47/06; B01D 2247/08; F01N 3/08

(57) ABSTRACT

An exhaust gas purification system includes an exhaust gas capturing device and a purifying device. The exhaust gas capturing device is for receiving exhaust gas generated by an exhaust gas generating device, and includes an accommodation unit that defines a plurality of accommodation spaces which are in fluid communication with outside of the accommodation unit and which are for accommodating the exhaust gas, and a flow control unit that is operable to inject the exhaust gas into the accommodation spaces and/or block the exhaust gas from flowing out of the accommodation spaces. The purifying device is installed in the exhaust gas capturing device, and is operable to purify the exhaust gas in the accommodation spaces.

### CROSS-REFERENCE TO RELATED APPLICATION

This application claims priority of Taiwanese Patent Application Nos. 108119548 and 109200093, respectively filed on Jun. 5, 2019 and Jan. 3, 2020.

### FIELD

The disclosure relates to a purification system, and more particularly to an exhaust gas purification system.

### BACKGROUND

Following industrial development, high temperature processing is used in machining processes of many materials. Therefore, many factories are equipped with combustion devices to provide the high temperature processing environments required in these processes. The fuels used in such combustion devices are generally coals or fossil fuels, and will generate a large amount of exhaust gas (smoke) that generally contains harmful substances such as particulate pollutants, sulfur oxides, hydroxides or the like. In order to prevent the exhaust gas generated during operations of such combustion devices from being directly discharged to the outside world and thus polluting the atmosphere, relevant environmental regulations have stipulated emission standards for the exhaust gas generated by such combustion devices. Therefore, exhaust gas purification devices are generally installed in such combustion devices to purify the exhaust gas. However, the conventional exhaust gas purification devices have poor purification effect.

### SUMMARY

Therefore, an object of the disclosure is to provide an exhaust gas purification system that can alleviate the drawback of the prior art.

According to the disclosure, the exhaust gas purification system is operatively associated with an exhaust gas generating device, and includes an exhaust gas capturing device and a purifying device. The exhaust gas capturing device is for receiving exhaust gas generated by the exhaust gas generating device, and includes an accommodation unit and a flow control unit. The accommodation unit includes a plurality of containers that respectively define a plurality of accommodation spaces which are in fluid communication with outside of the accommodation unit and which are for accommodating the exhaust gas. The flow control unit is operable to perform one of injecting the exhaust gas into the accommodation spaces, blocking the exhaust gas from flowing out of the accommodation spaces, and a combination thereof. The purifying device includes a plurality of sprinklers, each of which is installed at an upper portion of a respective one of the containers, and each of which is operable to sprinkle liquid in one of the accommodation spaces that corresponds to the respective one of the containers so as to purify the exhaust gas in said one of the accommodation spaces.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a first embodiment of an exhaust gas purification system according to the disclosure;

FIG. 2 is a fragmentary top view of the first embodiment;

FIG. 3 is a fragmentary partly sectional side view of the first embodiment;

FIG. 4 is a block diagram illustrating connections of a control device of the first embodiment;

FIG. 5 is a fragmentary perspective view of a second embodiment of the exhaust gas purification system according to the disclosure;

FIG. 6 is a block diagram illustrating connections of a control device of the second embodiment;

FIG. 7 is a fragmentary partly sectional top view of the second embodiment;

FIG. 8 is a fragmentary sectional side view of a container of the second embodiment;

FIG. 9 is a fragmentary perspective view of a first modification of the second embodiment; and

FIG. 10 is a fragmentary perspective view of a second modification of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

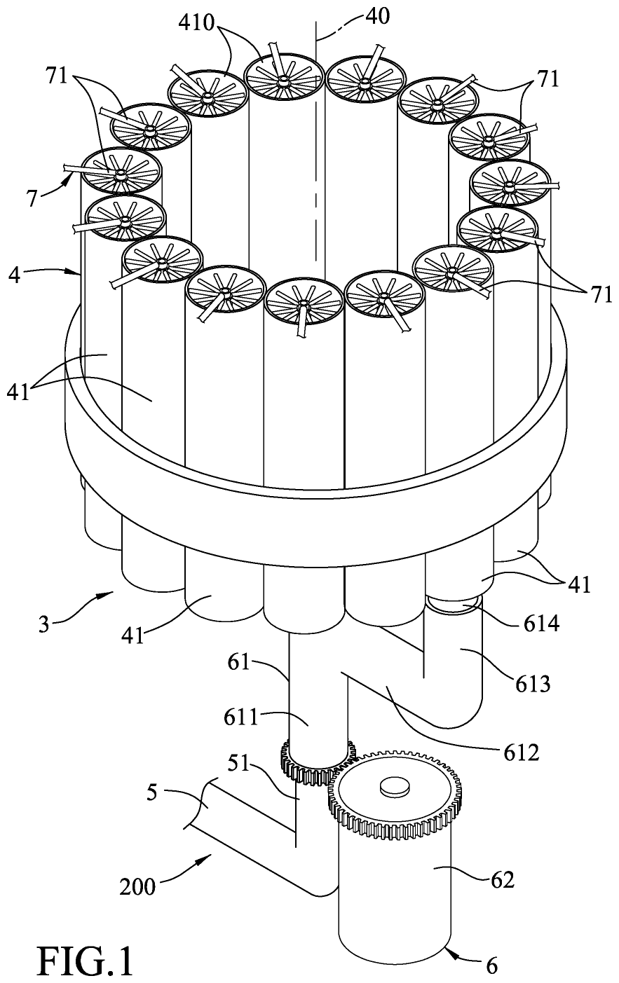

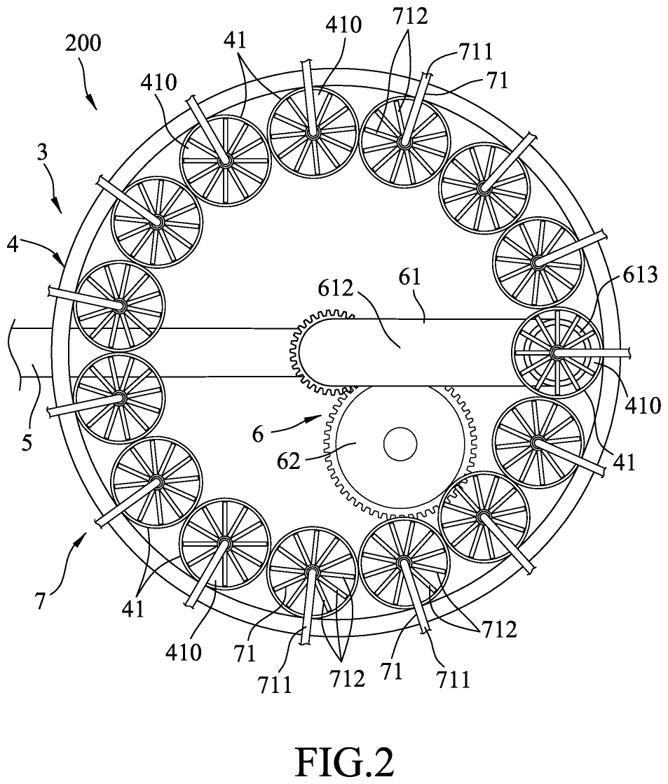

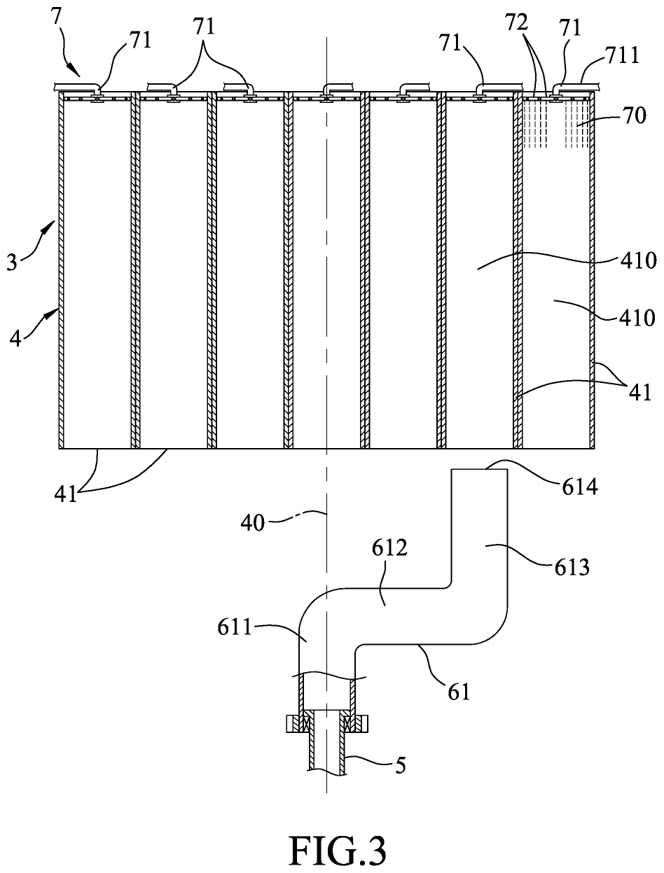

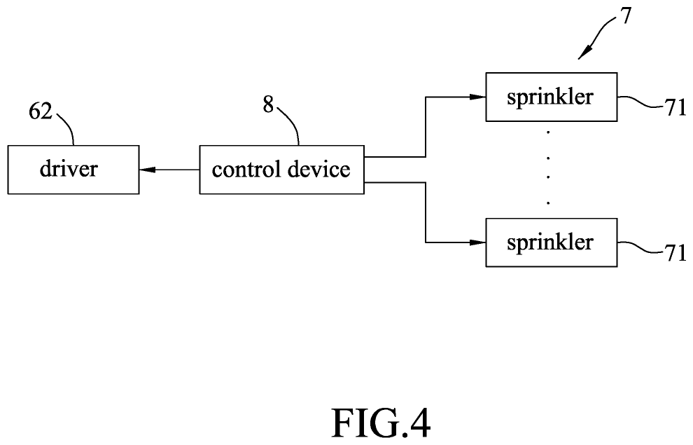

Referring to FIGS. 1 to 4, a first embodiment of an exhaust gas purification system 200 according to the disclosure is operatively associated with an exhaust gas generating device (not shown), and is adapted to purify exhaust gas generated by the exhaust gas generating device. The exhaust gas purification system 200 includes an exhaust gas capturing device 3, a purifying device 7 and a control device 8. The exhaust gas capturing device 3 is coupled to and in fluid communication with the exhaust gas generating device. The purifying device 7 is installed in the exhaust gas capturing device 3. The control device 8 is coupled to the exhaust gas capturing device 3 and the purifying device 7.

The exhaust gas capturing device 3 includes an accommodation unit 4, a gas delivery pipe 5 and a flow control unit 6. The gas delivery pipe 5 is coupled to and in fluid communication with the exhaust gas generating device, and is for transmitting the exhaust gas. The flow control unit 6 is rotatably coupled to the gas delivery pipe 5, and is disposed below and spaced apart from the accommodation unit 4.

The accommodation unit 4 includes a plurality of containers 41 (e.g., pipes) that extend vertically, and that are arranged annularly around a central axis 40 which extends vertically. Each of the containers 41 defines an accommodation space 410 that extends vertically therethrough and that is in fluid communication with an outside of the accommodation unit 4. In application, the containers 41 can be held above the flow control unit 6 by a stand (not shown). The gas delivery pipe 5 has a vertical section 51 that has an axis coinciding with the central axis 40. The flow control unit 6 has a dispensing pipe 61 and a driver 62. The dispensing pipe 61 is rotatably coupled to and in fluid communication with the gas delivery pipe 5. The driver 62 is coupled to the dispensing pipe 61, and is operable to drive the dispensing pipe 61 to rotate about the central axis 40. The dispensing pipe 61 has a first section 611, a second section 612 and a third section 613. The first section 611 is coaxially and rotatably coupled to the vertical section 51. The second section 612 extends horizontally from an upper end of the first section 611, and has a length that is equal to a radius of a ring formed by the arrangement of the containers 41 (i.e., a distance between the central axis 40 and each of the containers 41). The third section 613 extends upwardly from an end of the second section 612 distal from the first section 611, and can be right below any one of the accommodation spaces 410. The third section 613 has an outlet 614 that is at an upper end thereof, and that is for discharging the exhaust gas. When the dispensing pipe 61 is driven by the driver 62 to rotate about the central axis 40, the outlet 614 moves relative to the containers 41, and is sequentially aligned with and in fluid communication with the accommodation spaces 410.

The purifying device 7 includes a plurality of sprinklers 71 that are respectively installed at upper portions of the containers 41. Each of the sprinklers 71 has an input conduit 711 and a plurality of output conduits 712. The input conduit 711 extends into the upper portion of a corresponding one of the containers 41, and is for transmitting liquid 70 (e.g., water) that is used to purify the exhaust gas. The output conduits 712 are coupled to and in fluid communication with the input conduit 711, and extend horizontally and radially-outwardly from the input conduit 711. Each of the sprinklers 71 is operable to sprinkle the liquid 70 in a corresponding one of the accommodation spaces 410 through the output conduits 712, such that the sprinkled liquid 70 forms a mist in the corresponding accommodation space 410 to thereby adsorb suspended particles from the exhaust gas in the corresponding accommodation space 410 and achieve purification effect.

The control device 8 is programmed to control operations of the driver 62 and the purifying device 7. The control device 8 controls the driver 62 to periodically rotate the dispensing pipe 61 by a predetermined angle, so as to make the outlet 614 aligned with one of the accommodation spaces 410 for a predetermined time period (e.g., 10 seconds) to cause the exhaust gas to flow into the accommodation space 410 aligned therewith, and then move to be aligned with another one of the accommodation spaces 410 for the predetermined time period, and so on.

In addition, the control device 8 controls two of the sprinklers 71, which respectively correspond to the accommodation space 410 currently aligned with the outlet 614 and the accommodation space 410 to be aligned next with the outlet 614, to not sprinkle the liquid 70, and controls at least one of the sprinklers 71, which corresponds in a one-to-one relationship to at least one of the accommodation spaces 410 by which the outlet 614 just passed, to sprinkle the liquid 70.

By controlling the flow control unit 6 to inject the exhaust gas into the accommodation spaces 410 in a predetermined order, and by controlling the purifying device 7 to sprinkle the liquid 70 in the aforesaid way, the exhaust gas is dispensed to multiple containers 41, and the exhaust gas in each of the containers 41 is separately purified, resulting in high purification efficiency and high purification quality.

In application, the exhaust gas purification system 200 of this embodiment can be disposed at a side of the exhaust gas generating device with the gas delivery pipe 5 coupled to the exhaust gas generating device, so as to purify the exhaust gas. There is no need to dramatically change the structure of the exhaust gas generating device, or to rebuild the factory equipped with the exhaust gas generating device. Therefore, the exhaust gas purification system 200 of this embodiment has a convenient and practical design.

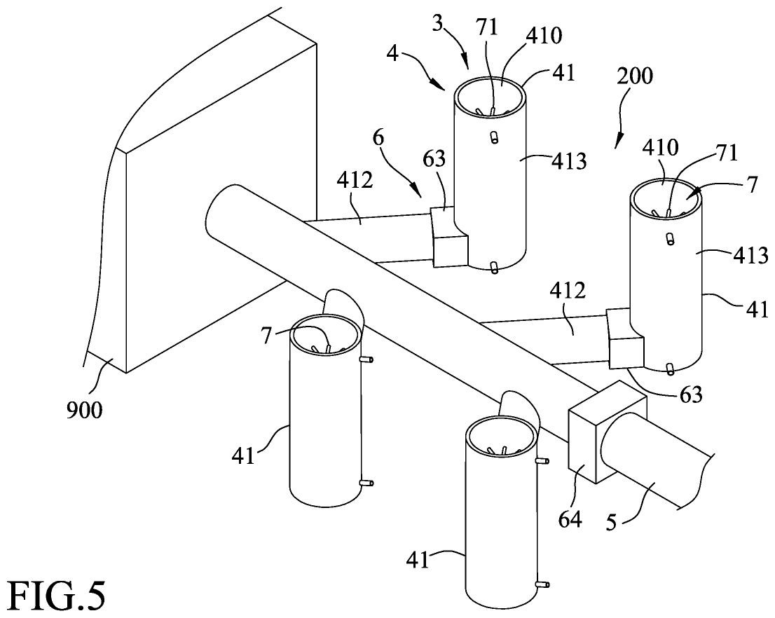

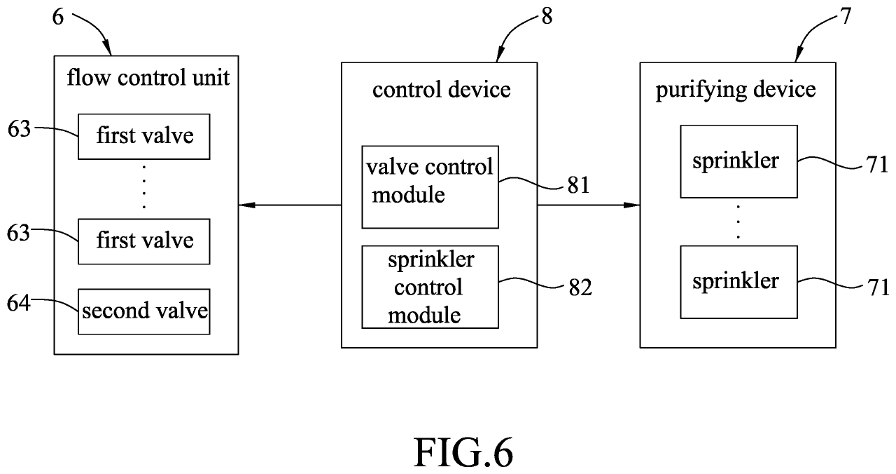

Referring to FIGS. 5 and 6, a second embodiment of the exhaust gas purification system 200 according to the disclosure differs from the first embodiment in the configurations of the exhaust gas capturing device 3 and the control device 8.

In the second embodiment, the accommodation unit 4 of the exhaust gas capturing device 3 includes a plurality of containers 41 that are arranged along the gas delivery pipe 5, and that are coupled to and in fluid communication with the gas delivery pipe 5. Each of the containers 41 has a tubular first section 412 and a tubular second section 413. The first section 412 extends horizontally from the gas delivery pipe 5, and is in fluid communication with the gas delivery pipe 5. The second section 413 extends vertically, has an open upper end and a closed lower end that is adjacent to an end of the first section 412 distal from the gas delivery pipe 5, and defines a respective accommodation space 410 that is in fluid communication with said first section 412 at a lower portion of the second section 413.

The flow control unit 6 includes a plurality of valves 63 and a valve 64. Each of the valves 63 is coupled between the first and second sections 412, 413 of a respective one of the containers 41. The valve 64 is installed in the gas delivery pipe 5 in such a way that the first sections 412 of the containers 41 are coupled to and in fluid communication with a section of the gas delivery pipe 5 between the exhaust gas generating device 900 and the valve 64.

Each of the valves 63, 64 is operable between an open state and a closed state. For each of the valves 63, when the valve 63 is open (i.e., in the open state), the exhaust gas in the gas delivery pipe 5 can flow into the first section 412 of the respective one of the containers 41, and then into the second section 413 of the respective one of the containers 41; and when the valve 63 is closed (i.e., in the closed state), the exhaust gas in the first section 412 of the respective one of the containers 41 cannot flow into the second section 413 of the respective one of the containers 41. When the valve 64 is closed (i.e., in the closed state), the exhaust gas cannot pass through the valve 64, and can flow into the second section(s) 413 of the container(s) 41 corresponding to the valve(s) 63 that is (are) open. Optionally, the valve 64 can have a gradual change between a fully open state and a closed state, so a rate of discharge of the exhaust gas from the gas delivery pipe 5 can be adjusted according to application requirements.

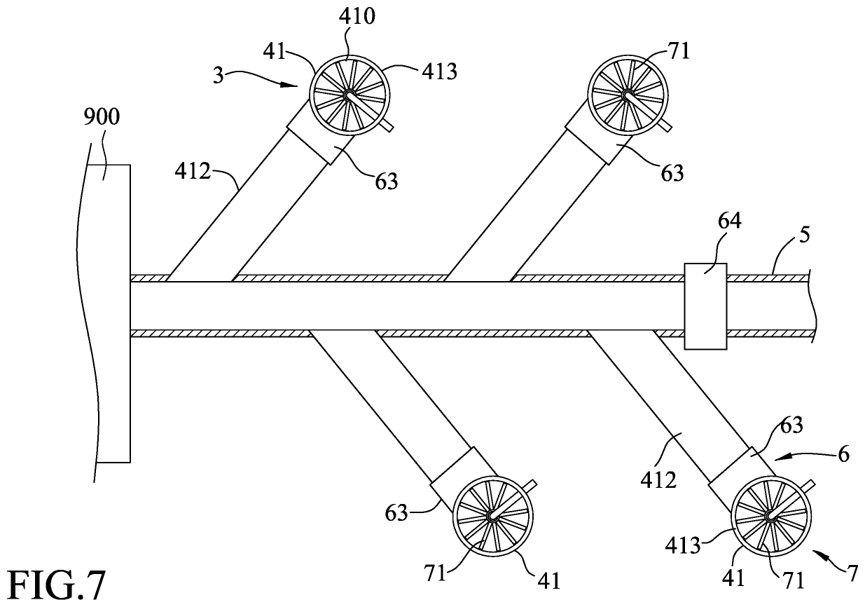

Referring to FIGS. 6 to 8, each of the sprinklers 71 is installed at an upper portion of the second section 413 of a respective one of the containers 41, and is operable to sprinkle the liquid 70 in one of the accommodation spaces 410 that corresponds to the respective one of the containers 41.

The control device 8 includes a valve control module 81 and a sprinkler control module 82.

The valve control module 81 is coupled to the valves 63, 64, and electrically or mechanically controls operations of the valves 63, 64. The valve control module 81 controls the valves 63 in such a way that not all of the valves 63 are simultaneously closed, and that each of the valves 63 periodically switches between the open state and the closed state with a predetermined duty cycle.

The sprinkler control module 82 is coupled to the sprinklers 71, and controls operations of the sprinklers 71 based on the operations of the valves 63. Each of the sprinklers 71 is controlled by the sprinkler control module 82 to start sprinkling liquid 70 for a predetermined period of time in one of the accommodation spaces 410 that corresponds to the respective one of the containers 41 when the valve control module 81 is controlling one of the valves 63 that corresponds to the respective one of the containers 41 to switch to the closed state, so a mist or a curtain of the liquid 70 drops in the second section 413 of the respective one of the containers 41 to thereby adsorb pollutants (e.g., dust particles, ash particles or the like) from the exhaust gas in the same and achieve purification effect.

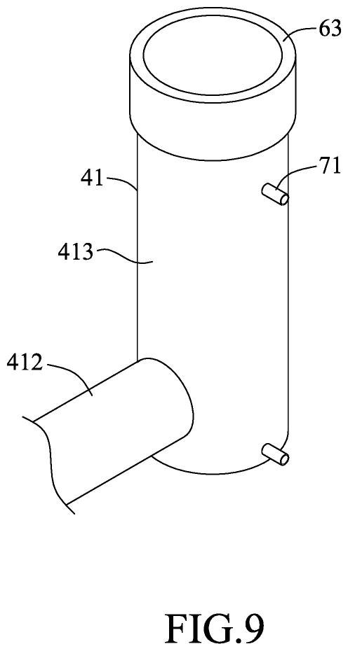

In this embodiment as shown in FIG. 5, each of the valves 63 of the flow control unit 6 is installed between the first and second sections 412, 413 of the respective one of the containers 41. However, in a first modification of this embodiment as shown in FIG. 9, each of the valves 63 is installed at the upper end of the second section 413 of the respective one of the containers 41, and the first and second sections 412, 413 of each container 41 are coupled to and in fluid communication with each other. Each of the valves 63, when closed, prevents fluid communication between the second section 413 of the respective one of the containers 41 and the outside world to block the discharge of the exhaust gas to the outside world. Each of the valves 63, when open, allows fluid communication between the second section 413 of the respective one of the containers 41 and the outside world and thus discharge of the exhaust gas to the outside world, so the second section 413 of the respective one of the containers 41 can receive the exhaust gas in the first section 412 of the respective one of the containers 41. In addition, the sprinklers 71 of the first modification of this embodiment are installed and controlled by the control device 8 (see FIG. 6) in the same way as the sprinklers 71 of this embodiment. The first modification of this embodiment also can enhance the purification efficiency and the purification quality.

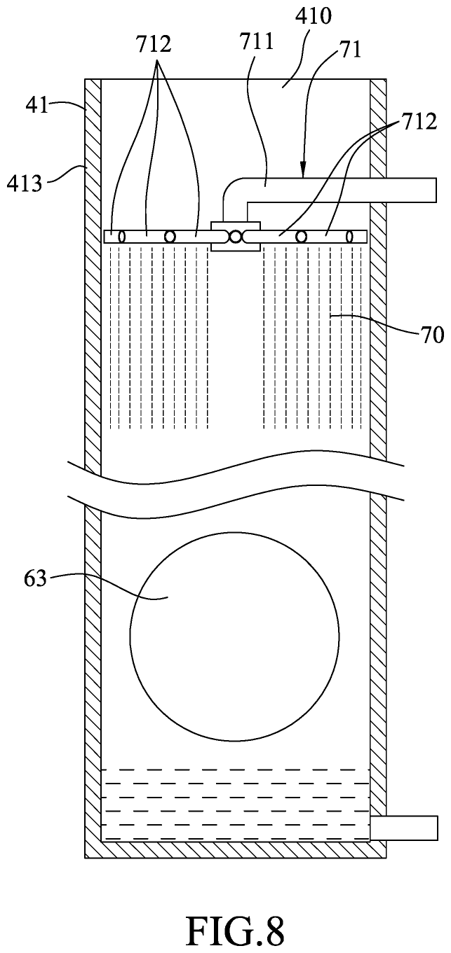

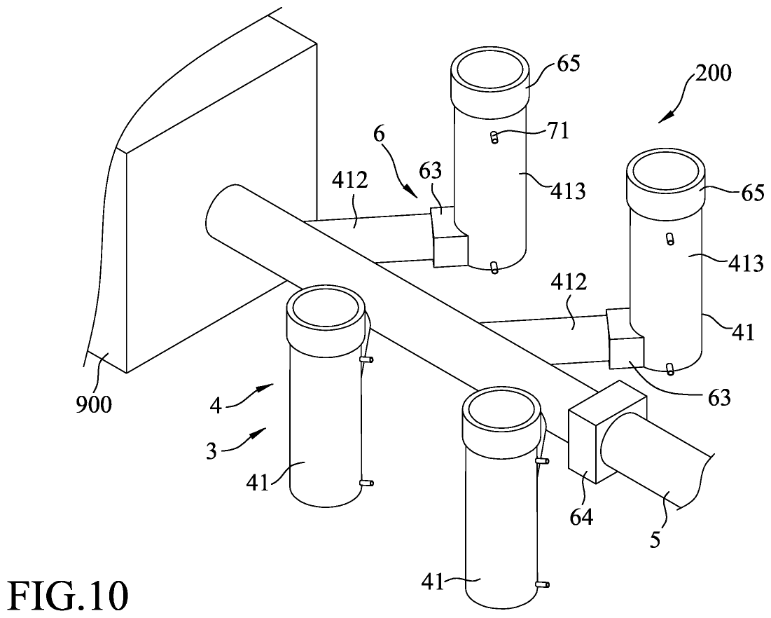

In a second modification of this embodiment as shown in FIG. 10, the flow control unit 6 further includes a plurality of valves 65 that are installed, and that operate and are controlled by the control device 8 (see FIG. 6) in the same way as the valves 63 (see FIG. 9) of the first modification of this embodiment. In addition, the sprinklers 71 of the second modification of this embodiment are installed in the same way as the sprinklers 71 of this embodiment, and each are controlled by the control device 8 (see FIG. 6) to start sprinkling liquid 70 (see FIG. 8) for a predetermined period of time in one of the accommodation spaces 410 that corresponds to the respective one of the containers 41 when the control device 8 (see FIG. 6) is controlling one of the valves 63 that corresponds to the respective one of the containers 41 and one of the valves 65 that corresponds to the respective one of the containers 41 to switch to the closed state. The second modification of this embodiment also can enhance the purification efficiency and the purification quality.

Referring to FIGS. 1 and 5, in view of the above, for each of the aforesaid embodiments, by virtue of the structural designs of the purifying device 7 and the exhaust gas capturing device 3, the accommodation spaces 410 are filled with the exhaust gas, and the small amount of the exhaust gas in each of the accommodation spaces 410 is separately purified, thereby attaining high purification efficiency and high purification quality. In addition, the exhaust gas purification system 200 can be easily coupled to the existing exhaust gas generating device 900 in the existing factory, and there is no need to dramatically change the structures of the existing exhaust gas generating device 900 and the existing factory. Therefore, the exhaust gas purification system 200 is a convenient and practical design.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that the disclosure is not limited to the disclosed embodiments but is intended to cover various arrangements included within the spirit and scope of the broadest interpretation so as to encompass all such modifications and equivalent arrangements.

What is claimed is:

1. An exhaust gas purification system operatively associated with an exhaust gas generating device, said exhaust gas purification system comprising:
an exhaust gas capturing device for receiving exhaust gas generated by the exhaust gas generating device, and including an accommodation unit and a flow control unit, said accommodation unit including a plurality of containers that respectively define a plurality of accommodation spaces which are in fluid communication with outside of said accommodation unit and which are for accommodating the exhaust gas, said flow control unit being operable to perform one of injecting the exhaust gas into the accommodation spaces, blocking the exhaust gas from flowing out of the accommodation spaces, and a combination thereof; and
a purifying device including a plurality of sprinklers, each of which is installed at an upper portion of a respective one of said containers, and each of which is operable to sprinkle liquid in one of the accommodation spaces that corresponds to the respective one of said containers so as to purify the exhaust gas in said one of the accommodation spaces.

2. The exhaust gas purification system of claim 1, wherein: said exhaust gas capturing device further includes a gas delivery pipe for receiving the exhaust gas from the exhaust gas generating device; said flow control unit includes a dispensing pipe that is coupled to and in fluid communication with said gas delivery pipe, and a driver that is coupled to said dispensing pipe; said dispensing pipe has an outlet for discharging the exhaust gas; and said driver is operable to drive said dispensing pipe in such a way that said outlet moves and passes by the accommodation spaces to inject the exhaust gas thereinto.

3. The exhaust gas purification system of claim 2, further comprising a control device that is coupled to said driver and said purifying device, that controls said driver to drive said dispensing pipe, that controls said purifying device not to sprinkle liquid in one of the accommodation spaces which is in fluid communication with said outlet, and that controls said purifying device to sprinkle the liquid in at least one of the accommodation spaces by which said outlet just passed.

4. The exhaust gas purification system of claim 1, wherein said flow control unit includes a plurality of valves, each of which is installed at an upper end of a respective one of said containers, and each of which, when open, permits discharge of the exhaust gas from the respective one of said containers.

5. The exhaust gas purification system of claim 4, further comprising a control device, wherein: each of said containers has a section that defines a corresponding one of the accommodation spaces; and each of said sprinklers is installed at an upper portion of said section of the respective one of said containers, is coupled to said control device, and is controlled by said control device to start sprinkling liquid in said one of the accommodation spaces when said control device controls one of said valves that corresponds to the respective one of said containers to switch to a closed state.

6. The exhaust gas purification system of claim 1, wherein: said exhaust gas capturing device further includes a gas delivery pipe that is used to be coupled to and in fluid communication with the exhaust gas generating device, and that is for transmitting the exhaust gas; said containers are arranged along said gas delivery pipe, and are coupled to and in fluid communication with said gas delivery pipe; and said flow control unit includes a plurality of first valves, each of which is installed to a respective one of said containers, and each of which, when open, permits injection of the exhaust gas into one of the accommodation spaces that corresponds to the respective one of said containers.

7. The exhaust gas purification system of claim 6, wherein: said flow control unit further includes a second valve that is installed in said gas delivery pipe, and that, when closed, blocks transmission of the exhaust gas in said gas delivery pipe; and said containers are coupled to and in fluid communication with a section of said gas delivery pipe that is between the exhaust gas generating device and said second valve.

8. The exhaust gas purification system of claim 6, further comprising a control device, wherein: each of said containers has a section that defines a corresponding one of the accommodation spaces; and each of said sprinklers is installed at an upper portion of said section of the respective one of said containers, is coupled to said control device, and is controlled by said control device to start sprinkling liquid in said one of the accommodation spaces when said control device controls one of said first valves that corresponds to the respective one of said containers to switch to a closed state.

9. The exhaust gas purification system of claim 6, wherein said flow control unit further includes a plurality of second valves, each of which is installed at an upper end of a respective one of said containers, and each of which, when open, permits discharge of the exhaust gas from the respective one of said containers.

10. The exhaust gas purification system of claim 9, wherein: said flow control unit further includes a third valve that is installed in said gas delivery pipe, and that, when closed, blocks transmission of the exhaust gas in said gas delivery pipe; and said containers are coupled to and in fluid communication with a section of said gas delivery pipe that is between the exhaust gas generating device and said third valve.

11.The exhaust gas purification system of claim 9, further comprising a control device, wherein: each of said containers has a section that defines a corresponding one of the accommodation spaces; and each of said sprinklers is installed at an upper portion of said section of the respective one of said containers, is coupled to said control device, and is controlled by said control device to start sprinkling liquid in said one of the accommodation spaces when said control device controls one of said first valves that corresponds to the respective one of said containers and one of said second valves that corresponds to the respective one of said containers to switch to a closed state.
